(19) United States
(12) Patent Application Publication
(10) Pub. No.: US 2023/0306876 A1
(43) Pub. Date: Sep. 28, 2023

(54) ANATOMICAL MODELS AND METHODS OF USE

(71) Applicant: Models Plus, LLC, Kingsford Heights, IN (US)

(72) Inventors: Dominic D'Amico, Valparaiso, IN (US); Gerard Kleinsmith, Grovertown, IN (US); Joseph Maki, Town of Pines, IN (US); Jeffrey Maki, Laporte, IN (US)

(21) Appl. No.: 18/125,290

(22) Filed: Mar. 23, 2023

Related U.S. Application Data
(60) Provisional application No. 63/322,973, filed on Mar. 23, 2022.
(60) Provisional application No. 63/381,402, filed on Oct. 28, 2022.

(51) Int. Cl. G09B 23/32; G09B 23/34

(52) U.S. Cl. CPC G09B 23/32; G09B 23/34

(57) ABSTRACT

Anatomical models capable of mimicking a range of motion of a human skeletal joint. The models include first and second facsimile bone members having adjacent interconnected portions to define a facsimile skeletal joint, and a rod assembly. A first end of a rod of the rod assembly has a clamping assembly mounted thereto that includes clamping members for clamping a portion of the first facsimile bone member therebetween. The clamping assembly includes a clamping mechanism operable to collapse the clamping members toward each other to capture and compress the portion of the first facsimile bone member therebetween and prevent the first facsimile bone member from being removed either axially or transversely from the rod assembly.

### CROSS-REFERENCE TO RELATED APPLICATIONS

This application claims the benefit of U.S. Provisional Application No. 63/322,973 filed Mar. 23, 2022, and the benefit of U.S. Provisional Application No. 63/381,402 filed Oct. 28, 2022. The contents of these prior applications are incorporated herein by reference.

### BACKGROUND OF THE INVENTION

The present invention generally relates to anatomical models. The invention particularly relates to anatomical models capable of mimicking articulation of the human skeletal joints, for example, the knee and hip joints.

Orthopaedic demonstration and training models are available which include facsimile human skeletal bones capable of use in surgical education, including surgeries that include bone cutting and orthopaedic prosthesis placement. The quality of such models is generally judged by the extent to which they accurately reproduce their human component counterparts, particularly with relation to properties such as anatomical accuracy, tissue response to interaction with instruments (e.g., needles, scalpels, etc.), and biomechanics. While advances continue to be made in the quality of such models, there is an ongoing desire for more accurate models. In particular, many commercially available models are limited in their ability to accurately replicate the complex kinematics of human skeletal bones, especially for skeletal joints such as the knee (genu) and hip (acetabulofemoral) joints. Therefore, it can be appreciated that it would be desirable if anatomical models were available that were capable of more accurately mimicking the complex kinematics of human skeletal bones.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides anatomical models capable of mimicking a range of motion of a human skeletal joint, for example the human knee and hip joints.

According to a nonlimiting aspect of the invention, an anatomical model includes first and second facsimile bone members having adjacent interconnected portions to define a facsimile skeletal joint, and a rod assembly comprising a rod having oppositely-disposed first and second ends. The first end of the rod has a clamping assembly mounted thereto that comprises first and second clamping members for clamping a portion of the first facsimile bone member therebetween. The clamping assembly comprises a clamping mechanism operable to collapse the first and second clamping members toward each other to capture and compress the portion of the first facsimile bone member therebetween and prevent the first facsimile bone member from being removed either axially or transversely from the rod assembly, and operable to expand the first and second clamping members away from each other to release the portion of the first facsimile bone member therebetween and allow the first facsimile bone member to be removed both axially and transversely from the rod assembly.

According to another nonlimiting aspect of the invention, an anatomical model is provided that includes first and second facsimile bone members, upper and lower leg members, first and second ligament members, and a first holding assembly. The first facsimile bone member has a proximal end and a distal end wherein the distal end includes a facsimile distal portion of a human femur. The second facsimile bone member has a proximal end and a distal end wherein the proximal end includes a facsimile proximal portion of a human tibia. The upper leg member is representative of a portion of a human thigh and has proximal and distal ends. The distal end of the first facsimile bone member extends from the distal end of the upper leg member. The lower leg member is representative of a portion of a human lower leg and a human foot and has proximal and distal ends. The proximal end of the second facsimile bone member extends from the proximal end of the lower leg member. The first and second ligament members couple lateral sides of the distal end of the first facsimile bone member to the lateral sides of the proximal end of the second facsimile bone member to at least partially define a knee joint of the anatomical model. The knee joint is configured for articulation that mimics the articulation of the human knee joint. The distal end of the first facsimile bone member and the proximal end of the second facsimile bone member are aligned in a manner that mimics the anatomical alignment of the distal femur and the proximal tibia in the human knee joint during articulation of the knee joint. The first and second ligament members mimic tension properties of the human lateral and medial collateral ligaments during articulation of the knee joint. The first holding assembly is configured to be secured to a fixture, couple with the proximal end of the upper leg member, and provide a range of motion of the upper leg member that mimics the full range of motion of the human hip joint.

According to another nonlimiting aspect of the invention, a method is provided that includes coupling the second end of the first rod assembly to a fixture to provide a range of motion of the first rod assembly that mimics a range of motion of the human hip joint, optionally coupling the second end of the second rod assembly to a fixture to provide a range of motion of the first and second rod assemblies that mimics a range of motion of the human hip joint, and manually manipulating the anatomical model to adjust relative positions of the first facsimile bone member and the second facsimile bone member by articulating at least the first rod assembly to a position within a range of motion of the human hip joint and optionally articulating the second rod assembly to a position within a range of motion of the human knee joint.

Technical effects of anatomical models and methods as described above preferably include the ability to teach and/or practice anatomical, medical, and surgical concepts with accurate kinematics of the human hip and knee joints.

Other aspects and advantages of this invention will be appreciated from the following detailed description.

### BRIEF DESCRIPTION OF THE DRAWINGS

FIGS. 1 through 3 represent various views of a first embodiment of an anatomical model representing portions of a human leg in accordance with certain nonlimiting aspects of the invention.

FIGS. 4 and 5 represent nonlimiting embodiments of holding assemblies adapted for use with the anatomical model of FIGS. 1 through 3.

FIG. 6 represents an enlarged side view of components that define a knee joint of the anatomical model of FIGS. 1 through 3.

FIG. 7 represents flexion and extension of the anatomical model of FIGS. 1 through 3.

FIG. 8 represents a facsimile bone member of the anatomical model of FIGS. 1 through 3 wherein a portion of the facsimile bone member has been removed thereby revealing an internal structure of the facsimile bone member.

FIG. 9 represents a side view of a second embodiment of an anatomical model representing portions of a human leg in accordance with certain nonlimiting aspects of the invention.

FIG. 10 represents a side view of portions of the embodiment of FIG. 9.

FIG. 11 represents an isolated view of a leg portion of the anatomical model of FIGS. 9 and 10, and FIG. 12 represents an isolated view of a clamping mechanism of the leg portion.

FIGS. 13 and 14 are different isometric views of a third embodiment of an anatomical model of portions of a human leg and knee joint in accordance with certain nonlimiting aspects of the invention.

FIGS. 15, 16, and 17 are, respectively, side elevation, top plan, and end elevation views of the anatomical model of FIG. 13.

FIG. 18 is an enlarged isometric view of the second holding assembly of FIG. 14 in a first configuration.

FIG. 19 is an enlarged isometric view of the second holding assembly of FIG. 14 and a second configuration.

FIG. 20 is an enlarged isometric view in the dashed circle in FIG. 14 of the talus block assembly.

FIG. 21 is an enlarged isometric view in the dashed circle of FIG. 13 of the first holding assembly.

FIG. 22 is a different enlarged isometric view of the first holding assembly of FIG. 13.

FIG. 23 is a schematic partial representation of a human hip, spinal column, and femur.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular depicted embodiment could be eliminated, and also encompasses additional or alternative embodiments that combine two or more features or aspects shown and/or described as part of different depicted embodiments. Therefore, the appended claims, and not the detailed description, are intended to recite what are believed to be aspects of the invention, including certain but not necessarily all of the aspects and alternatives described in the detailed description.

Disclosed herein are anatomical models suitable for anatomical and medial education-related activities such as but not limited to surgical training activities that may include bone cutting and orthopaedic prosthesis placement. The models include components representative of various human tissues that are arranged relative to each other in anatomically accurate positions. Some or all of these components may be configured to reproduce certain properties of the human tissues represented thereby, including but not limited to tissue density, texture, color, etc. The models may further include the capability of moving or articulating these components relative to each other in manners which accurately mimic the kinematics of certain skeletal joints of the human body, such as the knee (genu), hip (acetabulofemoral), shoulder (glenohumeral), and/or elbow (articulatio cubiti: humeroulnar, humeroradial, and proximal radioulnar) joints. For convenience, certain aspects of the invention will be hereinafter described in reference to the human leg, including the hip and knee joints and tissues associated therewith. However, it should be understood that the invention is not necessarily limited to such embodiments and that the teachings herein may be more broadly applicable to other portions of the human body or portions of various animal bodies.

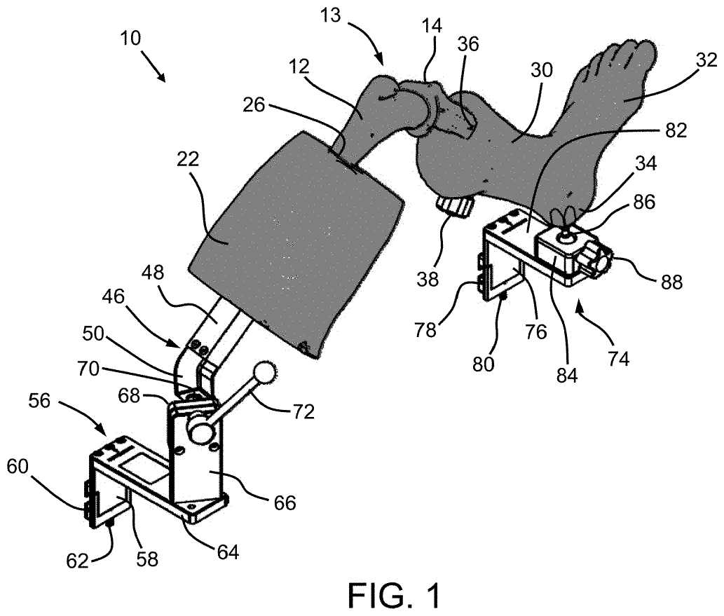

FIGS. 1 through 8 represent nonlimiting embodiments of an anatomical model 10 that is particularly adapted for use during various educational activities, such as teaching, learning, and practicing medical concepts and techniques such as, for example, robotic assisted knee arthroplasty surgery. The model 10 is specifically configured to not only reproduce certain human tissues associated with the human leg (a left leg in this nonlimiting illustrated embodiment), but to also provide for articulation that preferably mimics a full range of motion of both the human knee and hip joints. For convenience, some components of the model 10 will be referred to herein as having proximal/upper and distal/lower ends. Such terms refer to the anatomical positioning of the human tissue counterparts of the components relative to a human body while such human is standing.

As used herein, the phrase “full range of motion” of a human skeletal joint refers to a maximum amount of passive movement (i.e., due to an external force) capable for a specific joint in any direction as limited by the soft and hard tissues associated with the joint and without damaging such soft and hard tissues. Since the full range of motion is based on passive movements, the full range of motion may be in excess of a “normal range of motion” of the specific joint, which is based on active movements (i.e., requiring muscle contraction). Measurements of the full range of motion are generally measured in degrees and may be based on an average human as known in the art. The full range of motion of a joint may be dependent on certain aspects such as sex, age, weight, height, etc. As nonlimiting examples based on typical human capabilities, the full range of motion for the human hip joint may be equal to or greater than 0 to 100 degrees for flexion, 0 to 30 degrees for backward extension, 0 to 40 degrees for abduction, 20 to 0 degrees for adduction, 0 to 60 degrees for lateral rotation (i.e., rotation away from the center of the body), and 0 to 40 degrees for medial rotation (i.e., rotation toward the center of the body) and the full range of motion for the human knee joint may be equal to or greater than 0 to 150 degrees for flexion and 120 to 0 degrees for extension.

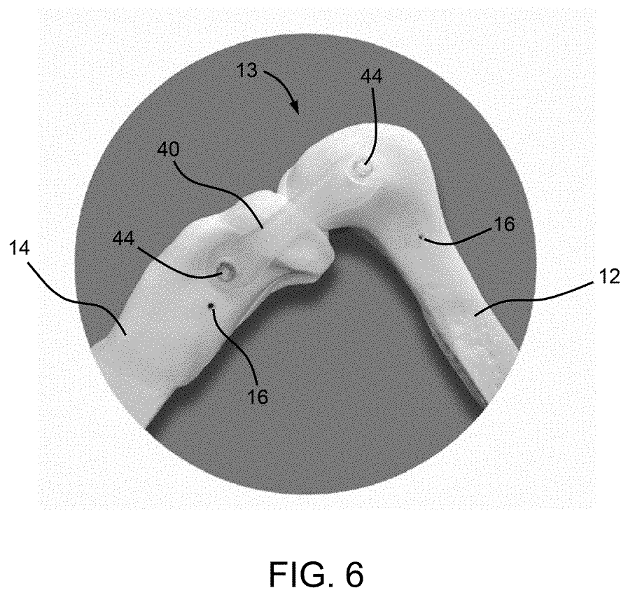

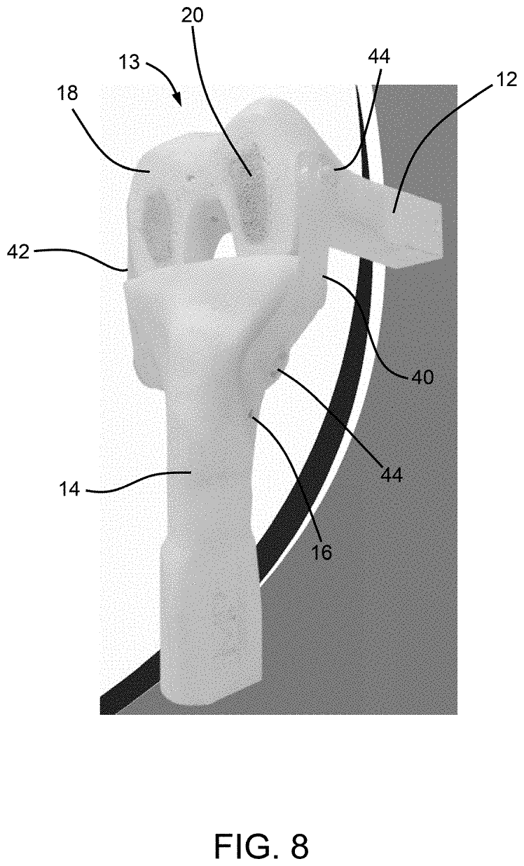

Referring to FIGS. 1 through 3, the model 10 includes exposed first and second facsimile bone members 12 and 14 extending from upper and lower leg members 22 and 30. In combination, the bone and leg members 12, 14, 22, and 30 represent portions of a human leg with certain soft and hard tissues adjacent the knee region omitted to expose the knee joint 13 between the facsimile bone members 12 and 14. In the example depicted in the drawings, the first facsimile bone member 12 is configured to provide a facsimile distal portion of a human femur, the second facsimile bone member 14 is configured to provide a facsimile proximal portion of a human tibia, the upper leg member 22 is configured to represent a portion of a human thigh, and the lower leg member 30 is configured to represent a portion of a human lower leg and a human foot 32. In addition, the model 10 includes exposed first and second ligament members 40 and 42 (FIGS. 6 and 8) coupling the first and second facsimile bone members 12 and 14. These ligament members 40 and 42 are configured to represent and mimic the human lateral and medial collateral ligaments. In certain examples, the knee region of the model 10 may include one or more additional components (not shown) configured to represent or reproduce the kneecap (patella) and/or other human tissues.

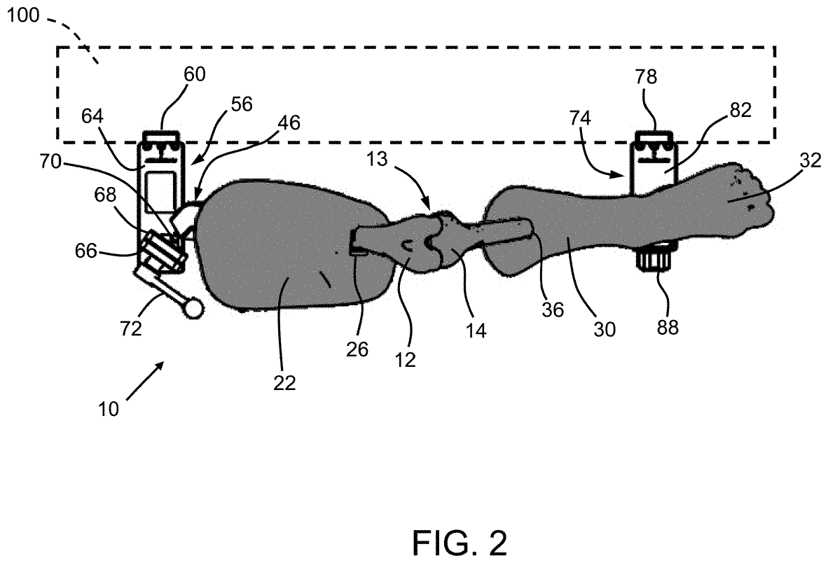

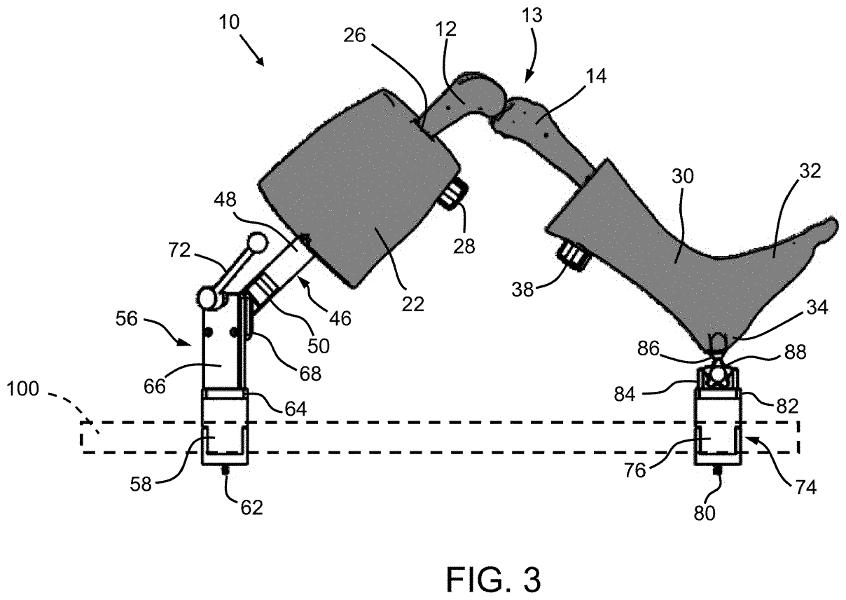

The upper leg member 22 and the lower leg member 30 are represented in the drawings as releasably supported with first and second holding assemblies 56 and 74, respectively. The first holding assembly 56 is coupled to a proximal end of the upper leg member 22 and configured to provide articulation to the upper leg member 22. Preferably, the first holding assembly 56 is configured to provide a range of motion to the upper leg member 22 that mimics a full range of motion provided by the human hip to the human thigh. The second holding assembly 74 is represented as coupled to a heel 34 of the foot 32 of the lower leg member 30. In the illustrated embodiments, the second holding assembly 74 is preferably capable of providing articulation to the lower leg member 30 to simulate the rolling of a human heel on a surface. Preferably, both of the holding assemblies 56 and 74 are capable of selectively fixing the positions of articulation of the respective leg members 22 and 30. In the embodiments shown in the drawings, the first and second holding assemblies 56 and 74 are configured to fix the position of the upper and/or lower leg members 22 and 30 such that the first and second facsimile bone members 12 and 14 are at proper anatomical orientations for the purpose of performing a surgical orthopaedic procedure. Each of the holding assemblies 56 and 74 may be configured to be rigidly secured to a fixture 100 or other equipment (FIGS. 2 and 3), such as a table. Various mechanisms may be used for securing the holding assemblies 56 and 74 to the fixture 100, including but not limited to various fasteners, clamping mechanisms, and rail systems.

In the nonlimiting example of FIGS. 1 through 3, the holding assembly 56 includes a mounting member 58 having a rail clamp 60 protruding from a face thereof and the holding assembly 74 includes a mounting member 76 having a rail clamp 78 protruding from a face thereof. The clamps 60 and 78 are represented as configured to receive therein side rails of a rail system, such as those commonly found on surgical tables, and to optionally be secured in position thereon with one or more fasteners or locking mechanisms. Extension flanges 64 and 82 are cantilevered from the mounting members 58 and 76, respectively, on a face thereof opposite the rail clamps 60 and 78. The first holding assembly 56 includes a rotation member 66 coupled to the extension flange 64 and configured for rotation about an axis perpendicular to a longitudinal axis of the extension flange 64. A ball joint assembly 68 is fixed to a face of the rotation member 66 adjacent a distal end thereof and a mounting rod 70 extends therefrom. The second holding assembly 74 includes a ball joint assembly 84 fixed directly to a face of the extension flange 82 with a mounting rod 86 extending therefrom. The first and second holding assemblies 56 and 74 each include locking mechanisms 62 and 80 configured to selectively and releasably fix the position of a ball of the ball joint assemblies 68 and 84 and thereby fix the position of the mounting rods 70 and 86, respectively. The locking mechanisms 62 and 80 may be controlled with a lever 72 and hand knob 88, respectively.

The mounting rod 70 of the first holding assembly 56 is represented in FIG. 2 as configured to interface with a recess in a proximal end of a shaft assembly 46 that includes a curved segment 50 and a linear segment 48 that are preferably releasably coupled to each other. Alternatively, the shaft assembly 46 could be an integral shaft. The linear segment 48 is configured to be secured to the proximal end of the upper leg member 22. In the nonlimiting example shown in the drawings, the linear segment 48 is received and releasably secured within a recess (not visible) defined in the proximal end of the upper leg member 22. The mounting rod 86 of the second holding assembly 74 is releasably received in a recess (not visible) defined in the heel 34 of the foot 32 of the lower leg member 30. Optionally, one or both of the mounting rods 70 and 86 may be configured to be secured in their respective recesses of the shaft assembly 46 and the heel 34 with, for example, a fastener or locking mechanism.

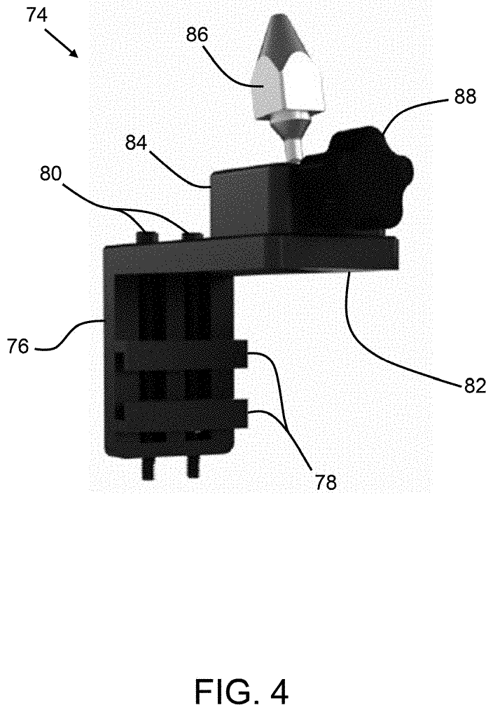

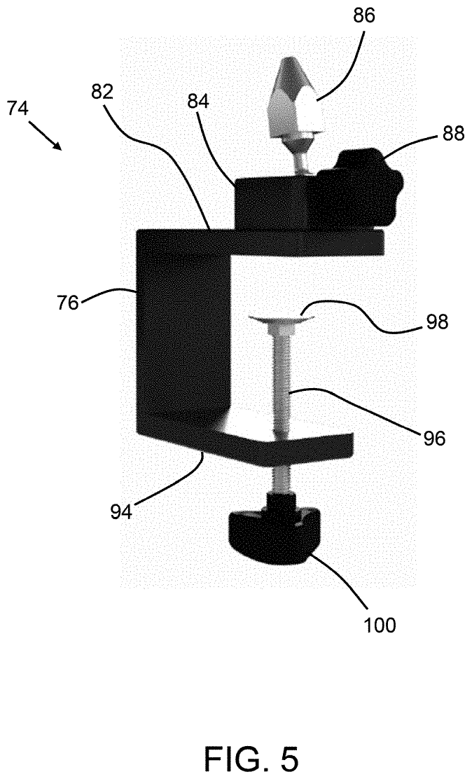

The mounting rods 70 and 86 of the first and second holding assemblies 56 and 74 may include distal ends configured to promote ease of insertion and securement within the recesses of the shaft assembly 46 and the lower leg member 30, respectively. In the embodiments represented in FIGS. 4 and 5, the distal end of the mounting rod 86 includes a body that transitions from a first portion having a rectangular cross section to a second portion having a conical cross section that ends with a rounded distal tip. The distal end of the mounting rod 70 may be similarly shaped. Sides of the first portion having the rectangular cross section may promote ease of fixing the positions of the mounting rods 70 and 86 with the locking mechanisms (if included), whereas the second portion having the conical section ending with a rounded tip may promote ease of insertion thereof into the corresponding recesses of the shaft assembly 46 and the lower leg member 30.

FIGS. 4 and 5 represent alternative examples of the second holding assembly 74. In FIG. 4, the rail clamp 78 of the second assembly 74 protrudes from an opposite face of the mounting member 76 relative to what is shown in FIGS. 1 and 2. The rail clamp 60 of the first assembly 56 can be similarly configured to protrude from an opposite face of the mounting member 58 relative to what is shown in FIGS. 1 and 2. In FIG. 5, instead of the rail clamp 78, the second holding assembly 74 includes an additional extension flange 94 and a bolt 96 threadably coupled thereto having a flat working end 98 and an opposite hand knob 100. These components, in combination with the mounting member 76 and the extension flange 82, define a C-clamp configured to releasably secure the second holding assembly 74 to the fixture 100. The first holding assembly 56 may have a similar clamping structure as shown for the second holding assembly 74 of FIG. 5.

The first and second facsimile bone members 12 and 14 are preferably releasably secured to the upper and lower leg members 22 and 30, respectively. In the nonlimiting embodiment represented in the drawings, the distal end of the upper leg member 22 and the proximal end of the lower leg member 30 include recesses 26 and 36, respectively, configured to receive and releasably secure proximal and distal ends of the first and second facsimile bone members 12 and 14 therein, respectively. In this example, clamping mechanisms 28 and 38 are threadably coupled to the upper and lower leg members 22 and 30 and operable via hand knobs to selectively contact and apply compressive forces on the facsimile bone members 12 and 14 within the recesses 26 and 36 to secure the ends of the facsimile bone members 12 and 14 therein, respectively.

The proximal and distal ends of, respectively, the first and second facsimile bone members 12 and 14 received within the recesses 26 and 36 of the upper and lower leg members 22 and 30, respectively, may have configurations that are facsimile portions of human bones. Alternatively, the proximal and distal ends of the first and second facsimile bone members 12 and 14, respectively, may have configurations that are not facsimile portions of human bones but instead are configured to promote ease of being received and/or secured within the recesses 26 and 36 of the upper and lower leg members 22 and 30. For example, in FIG. 8 the first facsimile bone member 12 includes a proximal end having a rectangular cross section and the second facsimile bone member 14 includes a distal end with an enlarged cross-sectional perimeter having a truncated stadium cross section.

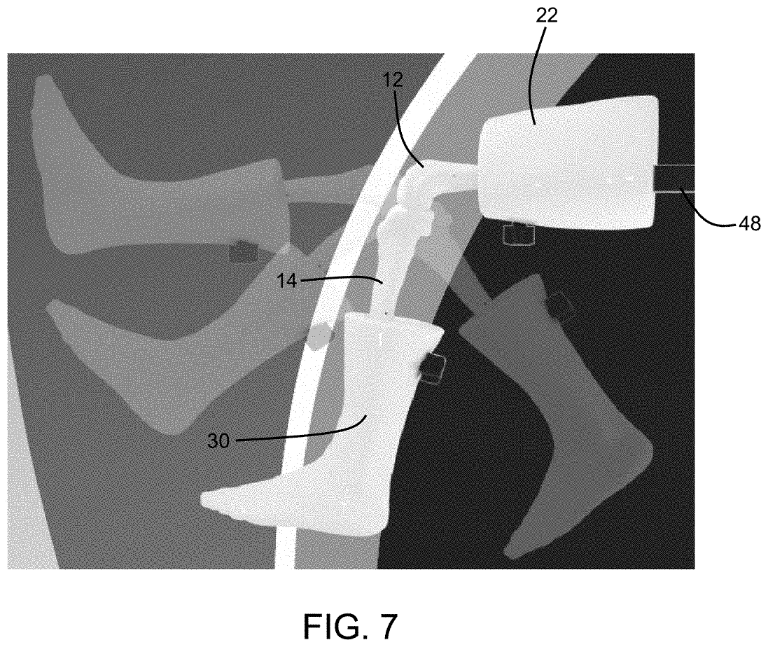

As noted previously, the first and second facsimile bone members 12 and 14 are represented as coupled with the first and second ligament members 40 and 42. The first and second ligament members 40 and 42 may be rotatably and releasably or permanently secured with, for example, fasteners 44 to lateral and medial sides of the distal and proximal ends of the first and second facsimile bone members 12 and 14, respectively. FIG. 6 represents an enlarged view of the first ligament member 40 secured to the lateral sides of the distal and proximal ends of the first and second facsimile bone members 12 and 14, respectively. Preferably, the first and second ligament members 40 and 42 are configured to align the distal and proximal ends of the first and second facsimile bone members 12 and 14, respectively, in a manner that mimics the anatomical alignment of the human distal femur and the proximal tibia in the knee joint 13 and maintain such alignment through the articulation of the first and second facsimile bone members 12 and 14 through a range of motion that mimics a full range of motion capable by a human knee, including full extension thereof as represented in FIG. 7. In addition, the first and second ligament members 40 and 42 are preferably though not necessarily configured to mimic tension properties of the human lateral and medial collateral ligaments during articulation of the first and second facsimile bone members 12 and 14. The tension properties of the first and second ligament members 40 and 42 may be tailored based on the materials of which the first and second ligament members 40 and 42 are formed, as well as the lengths, widths, and thicknesses of the first and second ligament members 40 and 42, profiles of the first and second ligament members 40 and 42 along longitudinal and lateral axes thereof, and locations of attachment of the first and second ligament members 40 and 42 to the first and second facsimile bone members 12 and 14 (which define axes of rotation thereof). The bilateral diaphysis clamps 126 and 136 are lock in place the metaphysis block on the distal ends of the facsimile bone members 112 and 114 (e.g., facsimile femur and tibia) to ensure the anatomical model can accurately mimic the anatomical position of the human femur and tibia, as exemplified in FIG. 23.

The first and second facsimile bone members 12 and 14 may be configured to couple with one or more additional components (not shown) configured to represent or reproduce other human tissues. In FIGS. 6 and 8, the first and second facsimile bone members 12 and 14 are each represented as including at least one portal 16 for receiving and securing therein a fastener, a connection member, or the like, by which one or more of additional components may be coupled to the first and/or second facsimile bone members 12 and 14. As nonlimiting examples, the additional components may include additional facsimile bone members that mimic a human patella and/or at least a proximal portion of a human fibula, additional ligament members, or other additional soft tissues (e.g., muscle, skin, etc.).

In the illustrated embodiments, in which the model 10 is intended to be used for practicing surgical techniques, the first and second facsimile bone members 12 and 14 may be further configured to mimic the distal portion of the human femur and the proximal portion of the human tibia, respectively, through an entirety of cross sections of the distal and proximal ends thereof, respectively. For example, FIG. 8 represents a cross section of the distal end of the first facsimile bone member 12. As represented, the first facsimile bone member 12 is formed to have an exterior portion 18 and an interior portion 20 that mimic the properties of the cortical and cancellous layers of human knees bones, respectively. The second facsimile bone member 14 may be similarly configured to have exterior and interior portions as those represented for the first facsimile bone member 12. The properties of such exterior and interior portions may differ, for example, in terms of density, texture, porosity, cross-sectional profile, thickness, etc. The facsimile knee bones 112 and 114 have the ability to be designed and customized to any anatomical representation of the human knee, while keeping the metaphysis portion of the bones unique to the design of the bilateral diaphysis clamps 126 and 136 to lock in place on the facsimile knee joint 113.

The model 10 provides for a method of performing anatomical and medial education-related activities which may include surgical training activities. The method may include securing one or both of the first and second holding assemblies 56 and 74 to the fixture 100 or other suitable equipment, such as a table. In the illustrated embodiments, the upper leg member 22 is coupled to the first holding assembly 56 by inserting the distal end of the mounting rod 70 thereof into the recess of the shaft assembly 46 and, optionally, securing the mounting rod 70 therein. The lower leg member 30 may optionally be coupled to the second holding assembly 74 by inserting the distal end of the mounting rod 86 thereof into the recess of the heel 34 of the foot 32 and, optionally, securing the mounting rod 86 therein. The distal and proximal ends of the first and second facsimile bone members 12 and 14, respectively, are represented as inserted into and secured within the recesses 26 and 36 of the upper and lower leg members 22 and 30, respectively. In the illustrated embodiments, the first and second ligament members 40 and 42 are represented as disposed at and secured to lateral and medial sides of the distal and proximal ends of the first and second facsimile bone members 12 and 14, respectively.

The model 10 may be manually manipulated to adjust the position of the components thereof relative to one another. In examples in which the lower leg member 30 is not coupled to the second holding assembly 74, the model 10 may be manipulated to articulate the first holding assembly 56 to any position within the full range of motion provided by the human hip joint and to articulate the first and second facsimile bone members 12 and 14 to any position within the full range of motion provided by the human knee joint. In examples in which the lower leg member 30 is coupled to the second holding assembly 74, the model 10 may be manipulated to articulate the second holding assembly 74 to any position within the range of motion provided by rolling the human heel on a surface and to articulate the first holding assembly 56 to any position within the full range of motion provided by the human hip as limited by the limited movement of the lower leg member 30 due to the connection to the second holding assembly 74. The method may include decoupling one or both of the first and second holding assemblies 56 and 74 from the fixture 100 prior to manipulating the model 10 to allow from a broader range of motion relative to the first and second holding assemblies 56 and 74 being secured to the fixture 100. In such examples, manipulating the model 10 may include sliding one or both of the first and second holding assemblies 56 and 74 along the fixture 100.

Once the components of the model 10 are located in desired relative positions, the components may be fixed in such positions with one or more locking mechanisms or fasteners. In some illustrated examples, the upper and lower leg members 22 and 30 are secured to the first and second holding assemblies 56 and 74 and fixed in relative articulatory positions in a manner such that the first and second facsimile bone members 12 and 14 are positioned at proper anatomical orientations for the purpose of performing the anatomical and medial education-related activities, such as but not limited to certain surgical orthopaedic procedures.

Once fixed in the desired orientation, the model 10 may be used to assist in performing the anatomical and medial education-related activities. This may include cutting one or both of the first and second facsimile bone members 12 and 14, detaching and/or reattaching one or both of the first and second ligament members 40 and 42, and/or securing one or more orthopaedic prostheses to the model 10. If the method includes permanently modifying one or more of the components of the model 10 (e.g., the facsimile bone members 12 and 14), the method may further include removing and replacing such components. As such, the model 10 provides the capability for repeatedly performing certain education-related activities without the necessity of replacing an entirety of the model 10 between such activities.

Alternative embodiments are contemplated in addition to the embodiments(s) shown and/or described herein. For example, one or more of the components of the model 10 may be altered or have different constructions than described herein to represent, reproduce, or mimic counterpart human tissue(s) that are damaged or otherwise abnormal due to injury, illness, birth defects, genetic disorder, etc. For example, the first and/or second facsimile bone members 12 and 14 may be configured to represent fractures, deterioration, or other conditions. The first and/or second ligament members 40 and 42 may be configured to represent ligament laxity, partial tear or rupture, or other conditions. Similarly, the range of motion provided by a joint of the model 10 may be adjusted to mimic a corresponding human joint that is capable of more or less than the full or normal range of motion of a corresponding healthy human joint in order to represent a damaged or abnormal human joint (e.g., ligament rupture, inflammation, etc.).

The model 10 and its components may be fabricated using various techniques and formed of various materials including those currently used in the anatomical model industry. Fabrication techniques may include but are not limited to computer numerical control (CNC) milling, laser milling, additive manufacturing, and manual sculpting. Suitable materials may include certain polymeric, metallic, ceramic, and composite materials having various structures and consistencies. Preferably, the materials used for facsimile components are configured to precisely reproduce the feel and/or interaction response of a corresponding human tissue. For example, a facsimile component may reproduce a human tissue response to a working instrument or diagnostic equipment such as a needle, scalpel, staple, ultrasound machine, x-ray machine, or other medical devices and systems. As a specific nonlimiting example, the first and second ligament members 40 and 42 may be formed of a silicone-based polymeric material.

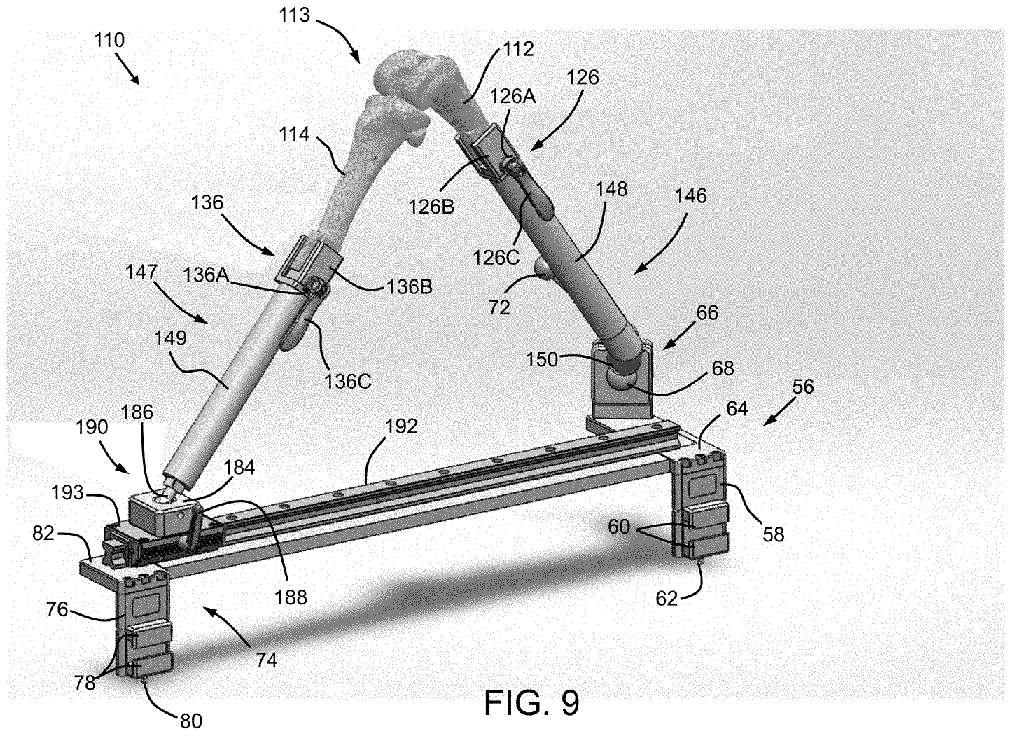

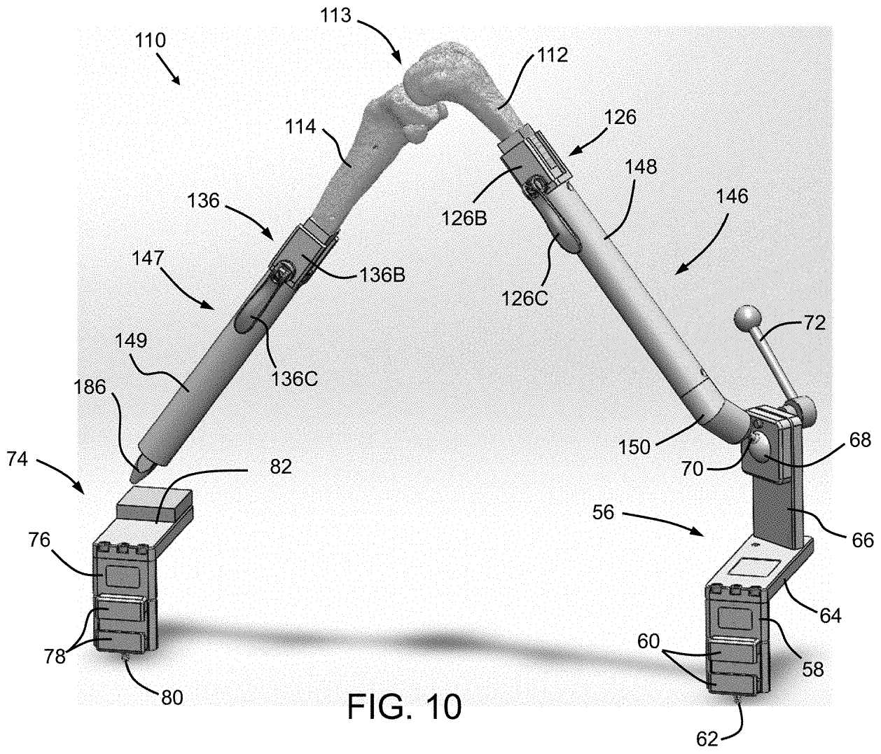

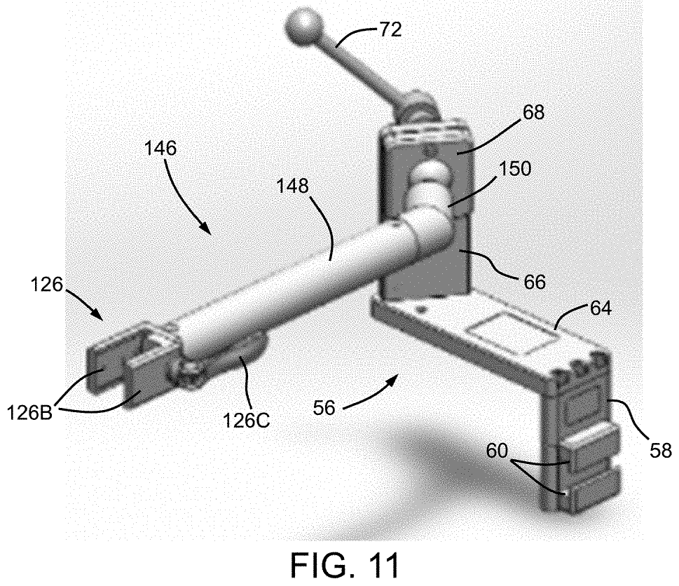

FIGS. 9 through 12 represent another nonlimiting embodiment of an anatomical model 110 within the scope of the invention. In these figures, consistent reference numbers are used to identify functionally related elements, but with a numerical prefix (1) added to identify certain elements to assist in distinguishing the embodiment of FIGS. 9 through 12 from the embodiments of FIGS. 1 through 8. For convenience, identical reference numerals are used in FIGS. 9 through 11 to denote elements of the holding assemblies 56 and 74 depicted in FIGS. 1 through 8. In view of similarities between the embodiments of FIGS. 9 through 12 and FIGS. 1 through 8, the following discussion of FIGS. 9 through 12 will focus primarily on aspects of this embodiment that differ from that of FIGS. 1 through 8 in some notable or significant manner. Other aspects of the embodiment of FIGS. 9 through 12 not discussed in any detail can be, in terms of structure, function, materials, etc., essentially as was described for the embodiment of FIGS. 1 through 8.

For purposes of illustration, the embodiment represented in FIGS. 9 through 12 omits the upper and lower leg members 22 and 30 shown in FIGS. 1 through 3, though it should be understood that these components can be incorporated in the embodiment of FIGS. 9 through 12. In FIGS. 9 through 12, a pair of rod assemblies 146 and 147 are coupled to, respectively, ball joint assemblies 68 and 184 of the first holding assemblies 56 and 74. The rod assemblies 146 and 147 each comprise a rod 148 and 149, whose lower ends couple to the first and second holding assemblies 56 and 74 and whose upper ends couple to the first and second facsimile bone members 112 and 114, respectively. The rod assemblies 146 and 147 are represented as further including bilateral diaphysis clamp assemblies 126 and 136 in place of the recesses 26 and 36 of the upper and lower leg members 22 and 30, respectively, depicted in FIGS. 1 through 3. The bilateral diaphysis clamping assemblies 126 and 136 are disposed at the upper ends of the rods 148 and 147, respectively, and each utilizes a “quick release” clamping mechanism 126A and 136A to collapse (contract) and expand (retract) a pair of clamping members 126B and 136B, respectively, relative to each other. In the particular but nonlimiting embodiment shown, the clamping mechanisms 126A and 136A are configured and operate similarly to what are commonly referred to as quick release skewers, such as those used to secure a wheel to a bicycle. By rotating a lever 126C or 136C associated therewith, the clamping assemblies 126 and 136 can be operated to collapse their respective clamping members 126B and 136B toward each other, thus capturing and compressing a portion of each of the first facsimile bone member 112 or the second facsimile bone member 114 therebetween and preventing the first and second facsimile bone members 112 and 114 from being removed either axially or transversely from their respective rods 148 and 149. The levers 126C and 136C can also be rotated to expand their respective clamping members 126B and 136B away from each other, thus releasing the captured and compressed portions of the first and second facsimile bone members 112 and 114 therebetween and allowing the first and second facsimile bone members 112 and 114 to be removed both axially and transversely from their respective rods 148 and 149. In each bilateral diaphysis clamping assembly 126 and 136, the quick release hub mechanism 126A constricts two opposing flat surfaces 126B together with a cam-functionality, which compress against a squared cutout of the diaphysis portion of the femur side and tibial side of the facsimile bones 112 and 114. Two teeth on each flat surface 126B provide a secured brake to prevent the flexus knee bones from sliding out axially. This quick lock assembly can replace historically threaded knob screws, which may promote carpal tonal and alleviate other problems with knob screws.

FIG. 9 further represents the model 110 as comprising a talus rotator unit 190 that comprises a post 186 received in the ball joint assembly 184 of the second holding assembly 74 to enable the rod assembly 147 to anatomically position itself to the talus portion of the foot 32. The ball joint assembly 184 is represented in FIG. 9 as mounted to a locking mechanism 193 disposed on a track 192 that enables flexion about the knee joint 113. The locking mechanism 193 is represented as operated with a lever 188 to allow the talus rotator unit 190 to be positioned and locked in an essentially infinite number of positions over the length of the track 192 and within a desired range of the displacement of flexion.

As with previous embodiments of the invention, the first holding assembly 56 utilizes the ball joint assembly 68 to enable anatomically positioning of the rod assembly 146 over three moments of rotation and enable the rod assembly 146 to be fastened/locked statically by a lever 72.

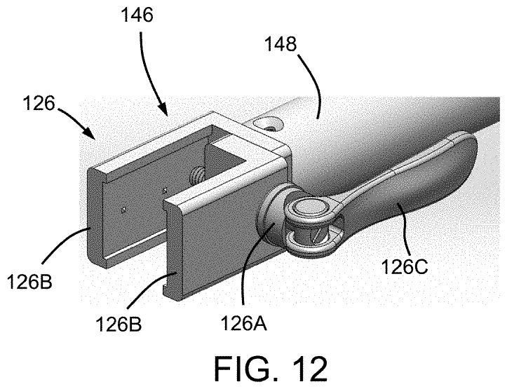

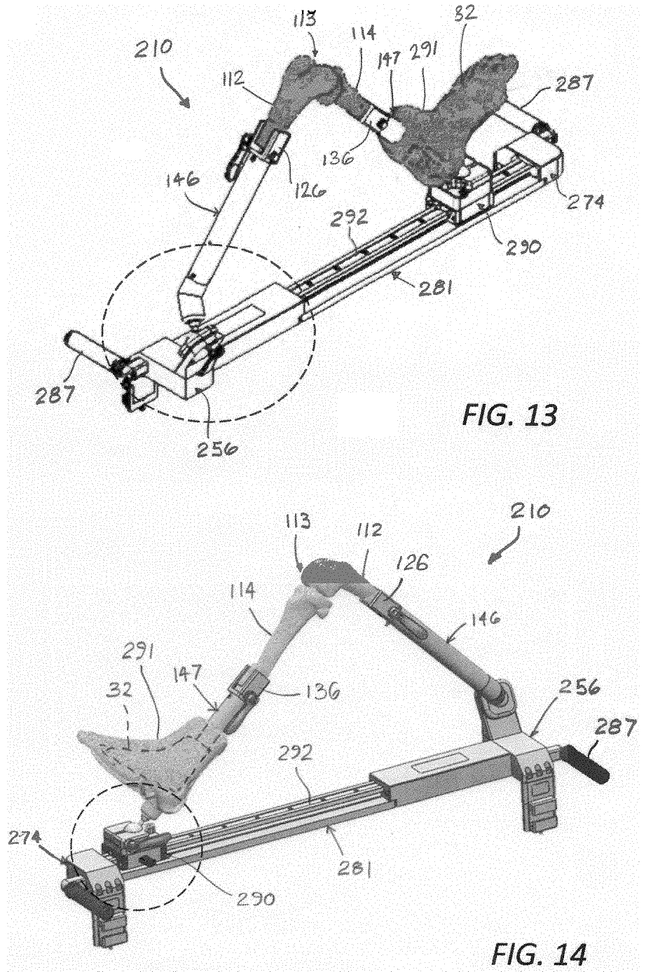

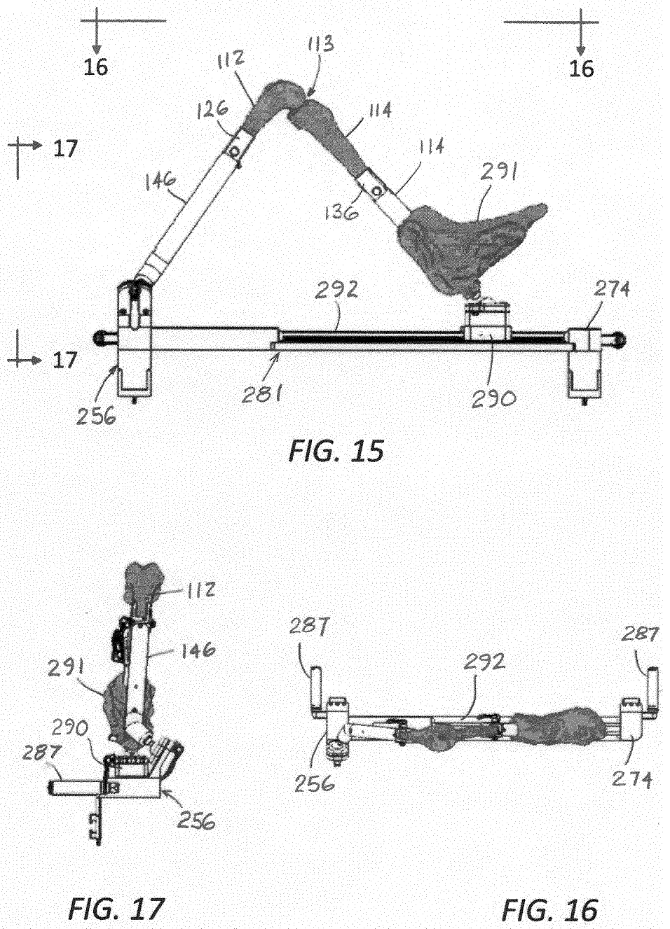

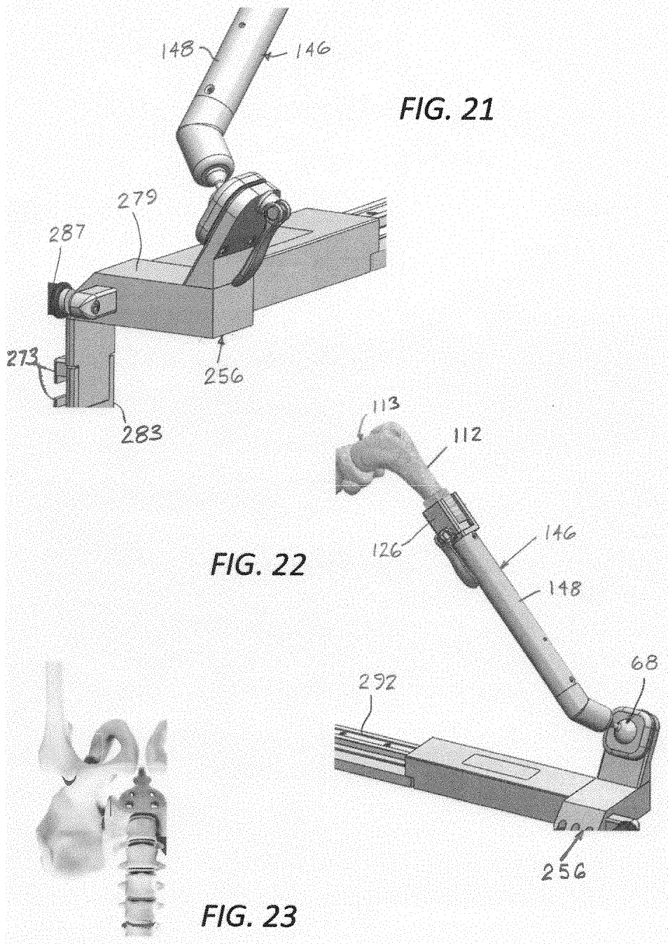

FIGS. 13 through 24 illustrate another nonlimiting embodiment of an anatomical model 210 within the scope of the invention. In these figures, consistent reference numbers are used to identify functionally related elements, but with a numerical prefix (2) added to identify certain elements to assist in distinguishing the embodiment of FIGS. 13 through 24 from the embodiments of FIGS. 1 through 8 and 9 through 12. For convenience, identical reference numerals are used in FIGS. 13 through 24 to denote subcomponents of the holding assemblies 256 and 274 depicted in FIGS. 9 through 12 that are substantially similar to the previously described subcomponents in FIGS. 9 through 12. In view of similarities between the embodiments of FIGS. 13 through 24 and FIGS. 1 through 12, the following discussion of FIGS. 13 through 24 will focus primarily on aspects of this embodiment that differ from that of FIGS. 1 through 12 in some notable or significant manner. Other aspects of the embodiment of FIGS. 13 through 24 not discussed in any detail can be, in terms of structure, function, materials, etc., essentially as was described for the embodiment of FIGS. 1 through 12.

As best seen in FIGS. 13-16, in this embodiment, the rod assemblies 147 and 146, facsimile bone members 114 and 112, and knee joint 113 are substantially the same as the corresponding components described in relation to FIGS. 9-12, and a foot 32 similar to that shown in FIG. 1 is secured to the distal end of the rod assembly 147, and thus the same reference numbers are used for corresponding components thereof and reference is made to the previous descriptions thereof without repeating the same here. The primary differences in the embodiment of FIGS. 13 through 24 relate to the first holding assembly 256, the second holding assembly 274, the talus block assembly 290, and the track 192.

As best seen in FIGS. 13 through 15, an assembly is coupled to the talus block assembly 290. The assembly includes a fractal shaped boot 291 that acts as a cradle mechanism that is configured to secure the prosthetic foot 32, for example, by a means of press fit. The boot 291 is located on the distal end of the assembly. The boot 291 couples to the mounting rod 186 of the talus block assembly 290 with any convenient permanent or releasable coupling assembly. While connected with the talus block assembly 290, the assembly allows 90 degrees of flexion about the distal portions of the knee bones (facsimile bone members 114 and 126). The prosthetic foot 32 is connected to the tibial rod assembly 147, which serves to mimic the anatomy of the lower leg.

In this embodiment, a mounting assembly 281 allows the anatomical model 210 to be easily mounted to and/or adjusted on a support structure, such as a table and/or a surgical bed (not shown). The mounting assembly 281 is formed by the first holding assembly 256 and the second holding assembly 274 that are permanently mounted to opposite ends of the track 292 and allow positioning and mounting of the anatomical model 210 on the support structure. The first holding assembly 256 is permanently attached to the “femoral/hip cup assembly” end of the track 292, and the second holding assembly 274 is permanently attached to the “talus block assembly” end of the track 292. Handle bars 287 disposed on opposite ends of the track 292 allow ease of placement and removal of the mounting assembly 281 onto a table or surgical bed.

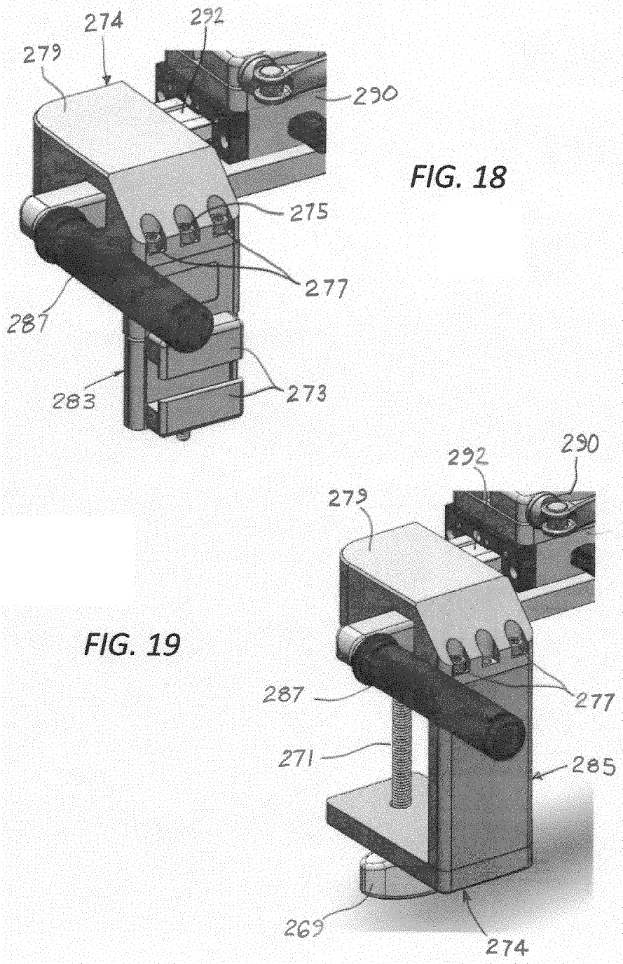

Each of the first and second holding assemblies 256 and 274 includes a mount body 279 that is attached to the track 292 and either of two mounting members, a rail clamp assembly 283 or a table clamp assembly 285, that can be interchangeably attached to the mount body 279 to allow the holding assemblies 256 and 274 to be mounted to either a table edge (table clamp assembly 285) or a rail (rail clamp assembly 283). As best seen in FIG. 18, the rail clamp assembly 283 includes a clamping mechanism for clamping to a rail slide mount on a surgical bed. A clamp screw 275 is configured to compress a pair of two opposing claws 273 to towards each other when the clamp screw 275 is tightened and to shift the pair of claws 273 away from each when the screw 275 is loosened. The claws 273 are generally similar to the rail clamps 60 and 78. The anatomical model 201 can thus be releasably clamped onto a rail slide mount of a surgical bed with the claws 273. The rail clamp assembly 283 is releasably attached to the mount body 279 by two screws 277 on each opposite side of the screw 275. The screws 277 allow the rail clamp assembly 283 to be removed from mount body 279 in exchange for the table mount assembly 285. The screws 277 also allow the rail clamp assembly 283 to be adjusted vertically relative to the mount body 274 to compensate for different surgical bed rails. As best seen in FIG. 19, the table clamp assembly 285 is configured for mounting to the edge of regular tables. The table clamp assembly 285 includes an elevator bolt 271 and knob 269 that fasten down a flat plate (not visible) underneath a table by means of a screw motion. Thus, the elevator bolt 271 allows the anatomical model 270 to be releasably mounted to a regular table. The table mount assembly 285 is attached to the mounting body 279 by the same two screw 277. In this configuration, the clamp screw 275 may be omitted because the table clamp assembly 285 does not include the claws 273 to be adjusted.

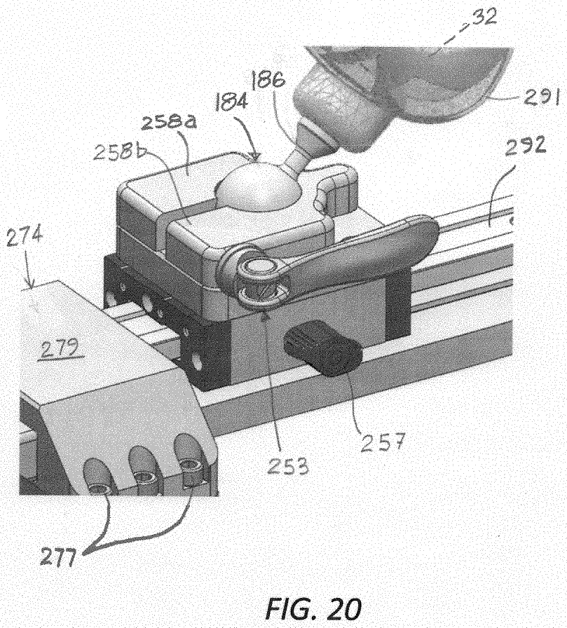

The talus block assembly 290 is slidably mounted on the track 292 extending between the first and second holding assemblies 256 and 274 such that it can slide along the track 292 between the first and second holding assemblies 256 and 274. As best seen in FIG. 20, the talus block assembly 290 includes a ball joint assembly 84 coupled to the facsimile surgical boot 291 that would be used in a real operating room scenario. The boot 291 anatomically positions itself to the talus portion of the foot 32. The ball joint assembly is secured down to a slide block (“linear bearing track”) 251 that is slidably mounted to the track 292. Sliding the slide block 251 axially along the length of the track 292 creates 90° of flexion about the distal sections of the facsimile bones 112 and 114 at the knee joint 113. The ball joint assembly 84 can be made static by means of a clamp lock 253 that compresses two open sections of metal 255a and 255b together that form the receiver portion of the ball joint assembly 84, preventing motion of the ball of the ball joint assembly 84. The slide block 251 has a rail lock 257 that engages the track 292 to releasably secure the talus block assembly 290 at a selected position along the track 292 and thus fix the knee joint 113 at a selected flexion angle within the range of the displacement of flexion. Thus, unlike the previous embodiments, in this embodiment, the talus block assembly 290 is movable along the track 292 separately from the holding assemblies 256 and 274, thereby allowing the flexion of the knee joint 113 to be adjusted independently without adjusting the mounting mechanism to the support structure.

The first holding assembly 256 includes a femoral/hip cup assembly configured to mimic an actual femur/hip joint, such as that shown for example in FIG. 23. The femoral/hip cup assembly is formed by a rotation member 266 generally similar to the ball joint assembly 66 in the embodiment of FIGS. 9 through 12. The rotation member includes a ball joint assembly 68 that anatomically positions itself to the proximal portion of the femoral head and pelvic cup of the femur/hip joint. The ball joint assembly 68 allows three moments of rotation and can be fastened/locked statically with a quick release hub 259 that clamps the ball in the socket, for example, with a camming action. The rotation member 266 is disposed at a non-orthogonal angle relative to the track 292 and the mount body 279 in order to more closely mimic the anatomical configuration of the pelvic socket and rotation of the human hip as shown in FIG. 23. The rod 148 in the rod assembly 146 is bent at an angle near the ball joint assembly 68 to also more closely mimic the geometry of the hip joint and the anatomical flexion and positioning of the human femur.

As previously noted above, though the foregoing detailed description describes certain aspects of one or more particular embodiments of the invention, alternatives could be adopted by one skilled in the art. For example, the models 10, 110, and 210 and their components could differ in appearance and construction from the embodiments described herein and shown in the figures, functions of certain components of the models 10, 110, and 210 could be performed by components of different construction but capable of a similar (though not necessarily equivalent) function, and various materials could be used in the fabrication of the models 10, 110, and 210 and/or their components. As such, and again as was previously noted, it should be understood that the invention is not necessarily limited to any embodiment described herein or illustrated in the drawings.

1. An anatomical model comprising:
first and second facsimile bone members having adjacent interconnected portions to define a facsimile skeletal joint;
a rod assembly comprising a rod having oppositely-disposed first and second ends, the first end of the rod having a clamping assembly mounted thereto, the clamping assembly comprising first and second clamping members for clamping a portion of the first facsimile bone member therebetween, the clamping assembly comprising a clamping mechanism operable to collapse the first and second clamping members toward each other to capture and compress the portion of the first facsimile bone member therebetween and prevent the first facsimile bone member from being removed either axially or transversely from the rod assembly, and operable to expand the first and second clamping members away from each other to release the portion of the first facsimile bone member therebetween and allow the first facsimile bone member to be removed both axially and transversely from the rod assembly.

2. The anatomical model of claim 1, further comprising a first holding assembly configured to be secured to a fixture, couple with the second end of the rod assembly, and provide a range of motion of the rod assembly that mimics a range of motion of the human hip joint.

3. The anatomical model of claim 2, wherein the first holding assembly includes a locking mechanism configured to selectively fix an articulatory position of the rod assembly.

4. The anatomical model of claim 1, further comprising a second rod assembly comprising a second rod having oppositely-disposed first and second ends, the first end of the second rod having a second clamping assembly mounted thereto, the second clamping assembly comprising first and second clamping members for clamping a portion of the second facsimile bone member therebetween, the second clamping assembly comprising a second clamping mechanism operable to collapse the first and second clamping members of the second clamping assembly toward each other to capture and compress the portion of the second facsimile bone member therebetween and allow the second facsimile bone member to be removed both axially and transversely from the second rod assembly.

5. The anatomical model of claim 4, further comprising a second holding assembly configured to be secured to the fixture, couple with the second end of the second rod assembly, and provide a range of motion of the second rod assembly relative to the rod assembly.

6. The anatomical model of claim 5, wherein the second holding assembly includes a locking mechanism configured to selectively fix an articulatory position of the second rod assembly.

7. The anatomical model of claim 5, wherein the second holding assembly comprises a locking mechanism disposed on a track that enables flexion about the facsimile skeletal joint.

8. The anatomical model of claim 1, wherein the first and second facsimile bone members include exterior and interior portions that mimic properties of cortical and cancellous layers of human bones, respectively.

9. The anatomical model of claim 1, wherein the anatomical model is configured for practicing robotic assisted knee arthroplasty surgery.

10. An anatomical model comprising:
a first facsimile bone member having a proximal end and a distal end wherein the distal end includes a facsimile distal portion of a human femur;
a second facsimile bone member having a proximal end and a distal end wherein the proximal end includes a facsimile proximal portion of a human tibia;
an upper leg member representative of a portion of a human thigh, the upper leg member comprising a first rod assembly comprising a first rod having oppositely-disposed first and second ends, the first end of the first rod having a first clamping assembly mounted thereto, the first clamping assembly comprising first and second clamping members for clamping a portion of the first facsimile bone member therebetween, the first clamping assembly comprising a first clamping mechanism operable to collapse the first and second clamping members toward each other to capture and compress the portion of the first facsimile bone member therebetween and prevent the first facsimile bone member from being removed either axially or transversely from the first rod assembly, and operable to expand the first and second clamping members away from each other to release the portion of the first facsimile bone member therebetween and allow the first facsimile bone member to be removed both axially and transversely from the first rod assembly;
a lower leg member representative of a portion of a human lower leg and a human foot, the lower leg member comprising a second rod assembly comprising a second rod having oppositely-disposed first and second ends, the first end of the second rod having a second clamping assembly mounted thereto, the second clamping assembly comprising first and second clamping members for clamping a portion of the second facsimile bone member therebetween, the second clamping assembly comprising a second clamping mechanism operable to collapse the first and second clamping members toward each other to capture and compress the portion of the second facsimile bone member therebetween and prevent the second facsimile bone member from being removed either axially or transversely from the second rod assembly, and operable to expand the first and second clamping members away from each other to release the portion of the second facsimile bone member therebetween and allow the second facsimile bone member to be removed both axially and transversely from the second rod assembly;
first and second ligament members disposed at and secured to lateral and medial sides of the first facsimile bone member and to lateral and medial sides of the second facsimile bone member to couple the first and second facsimile bone members and at least partially define a knee joint of the anatomical model, wherein the knee joint is configured for articulation that mimics articulation of the human knee joint, wherein adjacent ends of the first and second facsimile bone members are aligned in a manner that mimics the anatomical alignment of the femur and the tibia in the human knee joint during articulation of the knee joint, and the first and second ligament members mimic tension properties of the human lateral and medial collateral ligaments during articulation of the knee joint;
a first holding assembly configured to be secured to a fixture, couple with the second end of the first rod assembly, and provide a range of motion of the first rod assembly that mimics a range of motion of the human hip joint; and
a second holding assembly configured to be secured to the fixture, and provide a range of motion of the second rod assembly relative to the rod assembly.

11. The anatomical model of claim 10, wherein the first holding assembly includes a first locking mechanism configured to selectively fix an articulatory position of the first rod assembly.

12. The anatomical model of claim 10, wherein the second holding assembly includes a second locking mechanism configured to selectively fix an articulatory position of the second rod assembly.

13. The anatomical model of claim 10, wherein the second holding assembly comprises a locking mechanism disposed on a track that enables flexion about the facsimile skeletal joint.

14. The anatomical model of claim 10, wherein the first and second facsimile bone members include exterior and interior portions that mimic properties of cortical and cancellous layers of human bones, respectively.

15. The anatomical model of claim 10, wherein the anatomical model is configured for practicing robotic assisted knee arthroplasty surgery.

16. A method of using the anatomical model of claim 1, the method comprising:
coupling the second end of the first rod assembly to a fixture to provide a range of motion of the first rod assembly that mimics a range of motion of the human hip joint;
optionally coupling the second end of the second rod assembly to a fixture to provide a range of motion of the first and second rod assemblies that mimics a range of motion of the human hip joint; and
manually manipulating the anatomical model to adjust relative positions of the first facsimile bone member and the second facsimile bone member by articulating at least the first rod assembly to a position within a range of motion of the human hip joint and optionally articulating the second rod assembly to a position within a range of motion of the human knee joint.

17. The method of claim 16, wherein articulation of the first rod assembly is limited by the position of the second rod assembly.

18. The method of claim 16, wherein the anatomical model is manipulated such that the first and second facsimile bone members are positioned at anatomical orientations for practicing robotic assisted knee arthroplasty surgery.

19. The method of claim 16, further comprising cutting one or both of the first and second facsimile bone members, detaching and/or reattaching one or both of the first and second ligament members, and/or securing one or more orthopaedic prostheses to the anatomical model.

20. The method of claim 16, further comprising:
using the anatomical model for activities that cause permanent modification of the first and/or second facsimile bone members; and
removing and replacing the modified first and/or second facsimile bone members with identical replacements.

21. The anatomical model of claim 10, wherein the first holding member comprises:
a mount body attached to a track; and
a mounting member releasably attached to the mount body with a screw;
wherein the mounting member comprises either of a rail clamp assembly and a table clamp assembly that can be interchangeably attached to the mount body with the screw, wherein the rail clamp assembly is configured to clamp to a rail slide mount, and wherein the table clamp assembly is configured to clamp to an edge of a table.

22. The anatomical model of claim 21, wherein a height of the first holding member comprising the rail clamp assembly can be adjusted with the screw.

23. The anatomical model of claim 21, wherein the rail clamp assembly comprises:
a pair of two opposing claws; and
a clamp screw configured to shift the claws toward and away from each other to clamp onto a rail slide mount.

24. The anatomical model of claim 10, comprising:
a mounting assembly comprising the first holding assembly and the second holding assembly disposed at opposite ends of a track; and
a talus block assembly slidably mounted to the track, wherein the talus block assembly includes a ball joint assembly coupled to a boot, wherein the boot is configured to capture the human foot portion of the lower leg member.

25. The anatomical model of claim 24, wherein the first holding assembly a ball joint assembly disposed at a non-orthogonal angle relative to the track to mimic the anatomical configuration of the pelvic socket and rotation of the human hip.
